(19) United States
(12) Patent Application Publication
(10) Pub. No.: US 2015/0070327 A1
(43) Pub. Date: Mar. 12, 2015

(54) OPTICAL TOUCH PANEL AND TOUCHSCREEN

(71) Applicants: Tsung-Yen Hsieh, Taichung City (TW); Chong-Yang Fang, Taichung City (TW); Wen-Chun Wang, Taichung City (TW)

(72) Inventors: Tsung-Yen Hsieh, Taichung City (TW); Chong-Yang Fang, Taichung City (TW); Wen-Chun Wang, Taichung City (TW)

(73) Assignee: WINTEK CORPORATION, Taichung City (TW)

(21) Appl. No.: 14/483,163

(22) Filed: Sep. 11, 2014

(30) Foreign Application Priority Data
Sep. 11, 2013 (TW) 102132853

(51) Int. Cl. G06F 3/042

(52) U.S. Cl. CPC G06F 3/0421
USPC 345/175

(57) ABSTRACT

An optical touch panel including a light guide plate, at least one light-emitting element and a plurality of optical sensing elements and a touchscreen using the same are provided. The light guide plate has a plurality of lateral surfaces, a top surface, a bottom surface and a light extraction structure. The light-emitting element provides a light beam entering the light guide plate. The optical sensing elements are disposed under the bottom surface of the light guide plate. Each of the optical sensing elements has a sensing surface not parallel to the bottom surface of the light guide plate. The optical sensing elements are disposed at an illuminated region of the light beam provided by the light-emitting element. By the light extraction structure, a second portion of the light beam entered the light guide plate is scattered to the optical sensing elements from the bottom surface.

### CROSS-REFERENCE TO RELATED APPLICATION

This application claims the priority benefit of Taiwan application serial no. 102132853, filed on Sep. 11, 2013. The entirety of the above-mentioned patent application is hereby incorporated by reference herein and made a part of this specification.

### BACKGROUND OF THE INVENTION

1. Field of the Invention

The invention relates to a touch panel and a touchscreen, and more particularly to an optical touch panel and a touchscreen using the same.

2. Description of Related Art

In recent years, with information and electronic technologies progressed at a tremendous pace, touchscreens have been widely applied and led to applications and developments of consumer electronics products, such as portable electronic devices including cell phone, notebook computer, personal digital assistant (PDA), global positioning system (GPS). The touchscreens have become one independent industry owing to advantages in easy communication for users to perform intuitive inputs or operations through a touch panel and a display thereof.

Based on working principles of sensors, a touch panel technology can be generally categorized into types of resistive, capacitive, optical (also known as infrared) and acoustic-wave. Among them, an optical touch technology has a wide range of applications due to it is cost-friendly and capable of sensing touches by various materials including any object capable of interrupting light, such as a conductor (e.g., a finger) or a non-conductor (e.g., an insulating rubber pen). In case the touch panel is applied in medium and large displays, both resistive touch panels and capacitive touch panels require to use a sensor electrode made of a transparent conductive film approximately matching a size of the panel, thus a transmission impedance of the sensor electrode is significantly increased to further increase difficulty in sensing. Accordingly, process yield may be poor and cost may be higher, thus research and development in optical touch panel technology is now an important development direction in the field.

Currently, the optical touch sensing technology can be generally categorized into two types including light-beam interruption technology and frustrated total internal reflection (FTIR) technology. The light-beam interruption technology is a well-known optical touch architecture, which is a system including sensors and emitters (light sources) distributed at edges of the panel, or a system including sensors and emitters disposed at two corners on the same side of a substrate while a reflection structure is disposed at the other sides, so as to determine a contact position according to the light being interrupted by a finger. However, such a determination principle requires the sensors and light sources (emitters) being disposed around an operating surface of the panel, and thus a frame needs be disposed around the operating surface of the panel for covering elements such as the sensors, which causes a height drop and fails to realize a full flat design. On other hand, in an optical touch panel based on the FTIR optical touch sensing technology, a light guide plate, a light source, and an infrared camera are required. A sensing surface of the infrared camera is attached on the bottom surface of the light guide plate. Light provided by the light source is trapped within the light guide plate by a phenomena called “total internal reflection”. When a finger touches the light guide plate, the light is “frustrated” causing the light to escape internal reflection and scatter downwards (i.e., toward the inner side of the optical touch panel). Next, a variation of light intensity inside the light guide plate is sensed by the infrared camera. In addition, an image recognition for observing the contact position is performed. Said technology can be applied to realize a full flat surface touch panel. However, such detecting method is disadvantageous in detecting a real contact position since the sensing surface of the infrared camera therein facing external environment can easily be influenced by ambient light.

A full flat surface touch panel is currently a popular design of the touch panel for having an operating surface being full flat, and besides being a beautiful design, it can also solve problems cased by the conventional frame required by the electronic devices including sticking dirt, extra volume, extra thickness and extra weight.

### SUMMARY OF THE INVENTION

The invention is directed to an optical touch panel capable of providing a full flat surface appearance, and lower interferences from external light for improving efficiency and accuracy in touch detection.

The invention is also directed to a touchscreen having a full flat surface appearance and capabilities in both touch detection and display.

An optical touch panel of the invention includes a light guide plate, at least one light-emitting element and a plurality of optical sensing elements. The light guide plate has a plurality of lateral surfaces, a top surface, a bottom surface opposite to the top surface, and a light extraction structure. The top surface and the bottom surface connected together by the lateral surfaces. The light-emitting element has a light-emitting surface, and the light-emitting element provides a light beam entering the light guide plate. The optical sensing elements are disposed under a peripheral region of the bottom surface of the Light guide plate. Each of the optical sensing elements has a sensing surface, which is not parallel to the bottom surface of the light guide plate. The optical sensing elements are disposed within an illuminated region of the light beam provided by the at least one light-emitting element. Therein, a first portion of the light beam travels by total internal reflection in the light guide plate, and the light extraction structure makes a second portion of the light beam to leave from the bottom surface and project to the optical sensing elements.

A touchscreen of the invention includes a display and above-said optical touch panel. The display has a display surface. The bottom surface of the light guide plate of the optical touch panel faces the display surface of the display.

In an embodiment of the invention, a distance D between the sensing surface of the optical sensing element and the bottom surface satisfies a relationship below: 0<D≦G tan(20°); G is a diagonal length of the top surface of the light guide plate.

In an embodiment of the invention, a number of the at least one light-emitting element is plural, the light-emitting elements and the optical sensing elements are alternately arranged, and the light beam has a horizontal emission angle less than a vertical emission angle.

In an embodiment of the invention, a number of the at least one light-emitting element is plural, the lateral surfaces adjacent to the light-emitting elements are different from the lateral surfaces adjacent to the optical sensing elements, and the light beam has a horizontal emission angle less than a vertical emission angle.

In an embodiment of the invention, the at least one light-emitting element faces at least one of the lateral surfaces.

In an embodiment of the invention, a number of the at least one light-emitting element is plural, and the light-emitting elements surround the lateral surfaces.

In an embodiment of the invention, the optical touch panel further includes a light reflection layer configured to reflect the light beam, and the light reflection layer is disposed on a region of the top surface adjacent to the light-emitting element.

In an embodiment of the invention, an optical coupling layer is provided between the light-emitting surface of the at least one light-emitting element and the light guide plate, and a refractive index of the optical coupling layer is greater than air.

In an embodiment of the invention, the optical coupling layer is a scattering structure layer, an optical adhesive layer or a combination thereof.

In an embodiment of the invention, a region of the light guide plate facing the at least one light-emitting element has a plurality of microprism structures.

In an embodiment of the invention, a region of the light guide plate facing the at least one light-emitting element is a rough surface.

In an embodiment of the invention, the at least one light-emitting element faces the bottom surface of the light guide plate.

In an embodiment of the invention, the optical touch panel further includes a first optical structure is disposed in a periphery region of the light guide plate excluding the bottom surface to be opposite to the light-emitting surface of the at least one light-emitting element. The first optical structure may be a scattering structure layer, a specular reflection layer, a reflection structure, or a combination thereof.

In an embodiment of the invention, the first optical structure includes the reflection structure having a plurality of asymmetrical prisms, each of the asymmetrical prisms comprises a first oblique surface and a second oblique surface, the first oblique surface is closer to the lateral surfaces than the second oblique surface is, a length of the first oblique surface is greater than that of the second oblique surface, the first oblique surface reflects the light beam such that the light beam travels farther away from an optical axis of the at least one light emitting element.

In an embodiment of the invention, the first optical structure further includes the scattering structure layer or the specular reflection layer disposed on the reflection structure and the lateral surfaces.

In an embodiment of the invention, the reflection structure satisfies a condition: R_{ML}>2*T*tan(sin⁻¹(1/n)), in which R_{ML} is an extending length of the reflection structure extending outwardly from the lateral surfaces, T is a thickness of the light guide plate, and n is a refractive index of the light guide plate.

In an embodiment of the invention, the first optical structure comprises the reflection structure having a reflection oblique surface located between the lateral surfaces and the top surface, and an included angle between the reflection oblique surface and the lateral surfaces is not smaller than 135 degrees and not greater than 179 degrees.

In an embodiment of the invention, the first optical structure further comprises the scattering structure layer or the specular reflection layer disposed on the reflection oblique surface.

In an embodiment of the invention, the specular reflection layer or the scattering structure layer further extends to be located on a partial region of the top surface of the light guide plate and the partial region of the top surface of the light guide plate has a width satisfying a condition: R_{S}≧T*tan(sin⁻¹(1/n)), in which R_{S} is a width of the partial region of the top surface, T is a thickness of the light guide plate, and n is a refractive index of the light guide plate.

In an embodiment: of the invention, a thickness of the light guide plate is between 0.1 mm to 10 mm.

In an embodiment of the invention, a wavelength of the light beam is between 700 nm to 1000 nm.

In an embodiment of the invention, the light extraction structure comprises a plurality of scattering particles inside the light guide plate.

In an embodiment of the invention, the light extraction structure is a scattering layer disposed on the bottom surface.

In an embodiment of the invention, the light extraction structure comprises a plurality of micro-structures provided at the bottom surface of the light guide plate, and a surface roughness of the bottom surface is greater than zero and less than 1 μm.

In an embodiment of the invention, the optical touch panel further includes a control processor. As such, when an object contacts the optical touch panel, the optical sensing element corresponding to a contact position of the object outputs a contact characteristic corresponding to an attenuation of the second portion of the light beam, and the control processor calculates a coordinate of the contact position of the object according to the contact characteristic and a connecting relation of the optical sensing element and the light-emitting element.

In an embodiment of the invention, the greater a trough depth of the contact characteristic, the closer the object to the light-emitting element.

In an embodiment of the invention, the optical touch panel further includes a light shielding layer disposed between the bottom surface of the light guide plate and the optical sensing element.

In an embodiment of the invention, the at least one light-emitting element faces at least one of the lateral surfaces, and the light shielding layer reflects the light beam.

In an embodiment of the invention, the at least one light-emitting element faces the bottom surface, and the light beam is permitted to pass through the light shielding layer.

In an embodiment of the invention, the light shielding layer has a light permeable pattern, and the at least one light permeable element provides a portion of the light beam to pass the light permeable pattern.

In an embodiment of the invention, N numbers of the optical sensing elements are grouped into a sensing group for simultaneously receiving the second portion of the light beam and outputting a contact characteristic.

In an embodiment of the invention, an included angle between an extending direction of the sensing surface of the optical sensing element and a normal direction of the bottom surface is within 30 degrees.

In an embodiment of the invention, the optical touch panel further includes a plurality of optical absorbing elements respectively disposed between adjacent two of the optical sensing elements, wherein the optical absorbing elements satisfies a condition: (W/H)<2*tan(90°−sin⁻¹(1/n)), in which W is a pitch of the adjacent two of the optical absorbing elements, H is a distance from a projection of a center of the sensing surface of the optical sensing element on the optical absorbing element to a tip of the optical absorbing element, and n is a refractive index of the light guide plate.

In an embodiment of the invention, the touchscreen further includes a medium layer located between the display surface and the bottom surface of the light guide plate, and a refractive index of the medium layer is lower than a refractive index of the light guide plate.

In an embodiment of the invention, the light guide plate is made of a transparent material and has a haze lower than 20%.

In an embodiment of the invention, the touchscreen further includes a frame surrounding the display and the optical touch panel. The frame is substantially at the same elevation of the top surface.

In an embodiment of the invention, the light guide plate is a cover lens, and the lateral surfaces of the light guide plate further have an arc shape portions connecting to the top surface.

In an embodiment of the invention, the cover lens is a composite plate formed by stacking at least two different materials.

Based on above, since the light beam provided by the light-emitting element can travel inside the light guide plate and be scattered to the optical sensing element, the optical touch panel of the invention can be applied in touch sensing. In addition, by disposing the optical sensing element under the bottom surface of the light guide plate, the optical touch panel and the touchscreen can satisfy requirements for the full flat surface element. Further, since the sensing surface of the optical sensing element is not parallel to the bottom surface of the light guide plate, the invention has better able to resist the interference of ambient light, therefore has improved efficiency and accuracy in touch detection.

### BRIEF DESCRIPTION OF THE DRAWINGS

FIG. 1A is a schematic top view of an optical touch panel according to an embodiment of the invention.

FIG. 1B is a schematic side view of the optical touch panel depicted in FIG. 1A.

FIG. 1C is a schematic side view of the optical touch panel depicted in FIG. 1A being touched by an object.

FIG. 1D is a schematic view of another optical touch panel being touched by an object.

FIG. 2A to FIG. 2D are schematic side views of the light guide plate of FIG. 1A in different types.

FIG. 3A is a schematic top view of an optical touch panel according to another embodiment of the invention.

FIG. 3B is a schematic side view of the optical touch panel depicted in FIG. 3A.

FIG. 4A is a schematic top view of an optical touch panel according to yet another embodiment of the invention.

FIG. 4B is a schematic side view of the optical touch panel depicted in FIG. 4A.

FIG. 5A is a schematic top view of an optical touch panel according to still another embodiment of the invention.

FIG. 5B is a schematic side view of the optical touch panel depicted in FIG. 5A.

FIG. 6A to FIG. 6E are schematic side views of the light guide plate of FIG. 5A in different types.

FIG. 7A to FIG. 7E are schematic side views of light guide plate of FIG. 5A in different types.

FIG. 8A is a schematic top view of an optical touch panel according to yet another embodiment of the invention.

FIG. 8B is a schematic side view of the optical touch panel depicted in FIG. 8A.

FIG. 9A is a schematic side view of a touchscreen according to an embodiment of the invention.

FIG. 9B is a schematic side view of a touchscreen according to another embodiment of the invention.

FIG. 9C is a schematic side view of a touchscreen according to further another embodiment of the invention.

FIG. 10A is a schematic perspective view of a touchscreen according to further another embodiment of the invention.

FIG. 10B is a schematic top view of the touchscreen depicted in FIG. 10A.

FIG. 10C shows the disposition relationship of the optical absorbing element and the optical sensing element depicted in FIG. 10A.

### DESCRIPTION OF THE EMBODIMENTS

To make the above features and advantages of the disclosure more comprehensible, several embodiments accompanied with drawings are described in detail as follows. It should be noted that, numerical ranges provided in the following embodiments are used only for illustration, and are not intended to limit the scope of the present invention.

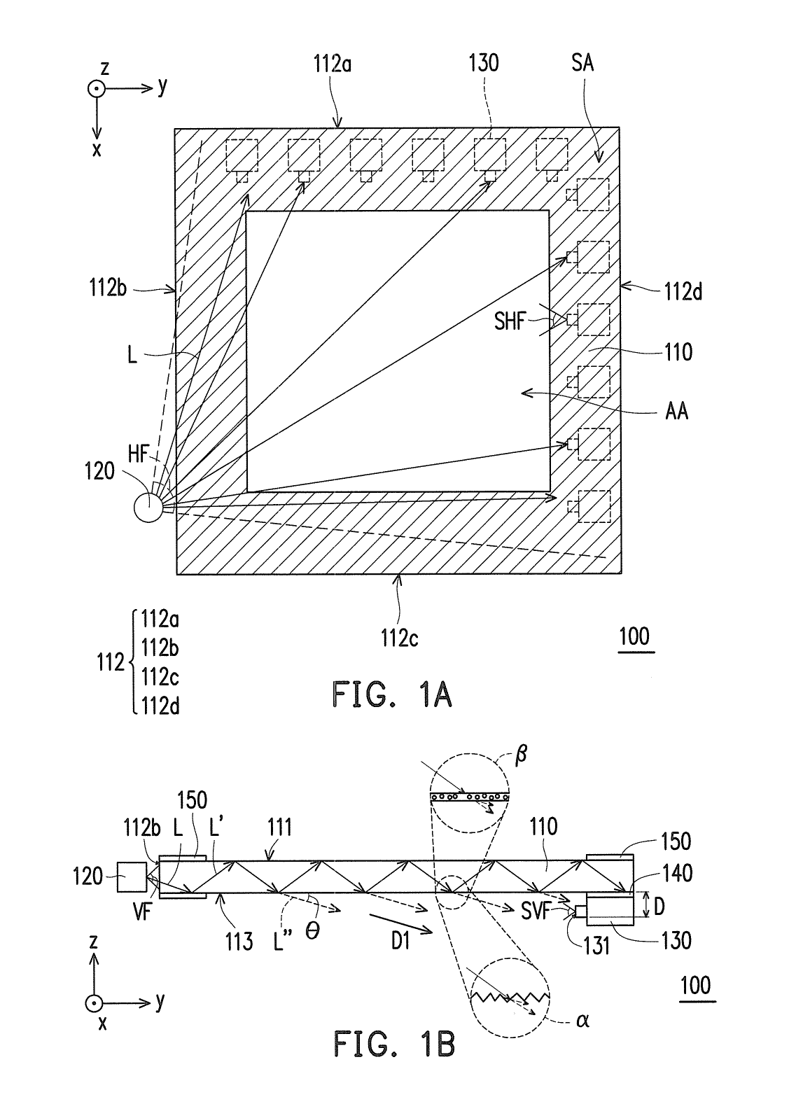

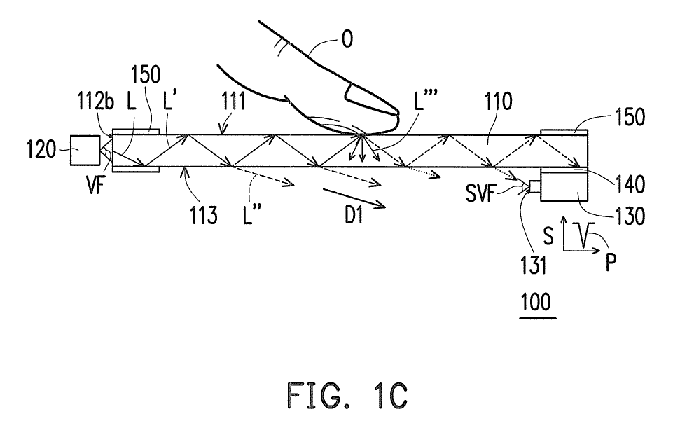

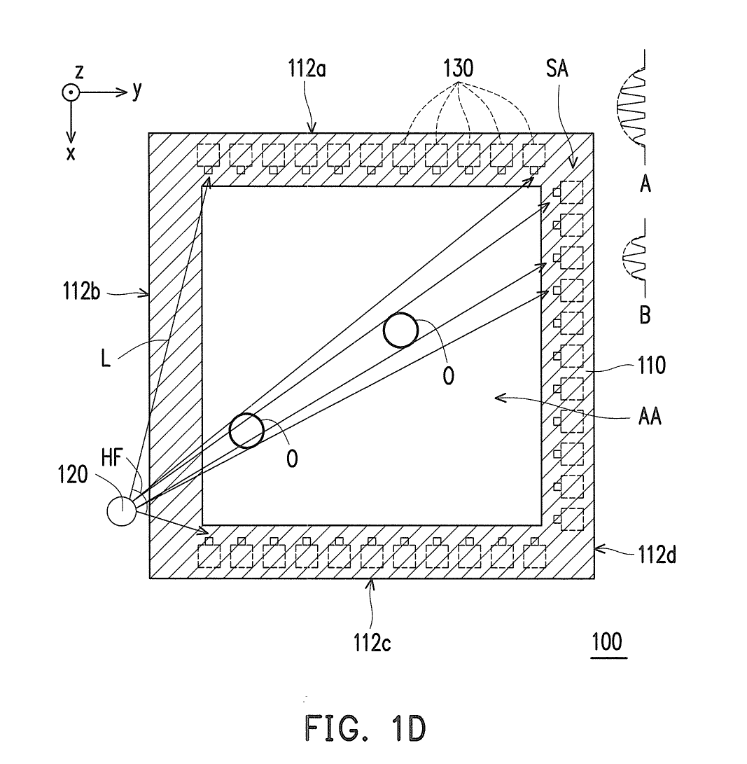

FIG. 1A is a schematic top view of an optical touch panel according to an embodiment of the invention. FIG. 1B is a schematic side view of the optical touch panel depicted in FIG. 1A. FIG. 1C is a schematic side view of the optical touch panel depicted in FIG. 1A being touched by an object. Referring to FIG. 1A to FIG. 1C, in the present embodiment, an optical touch panel 100 includes a light guide plate 110, at least one light-emitting element 120 and a plurality of optical sensing elements 130. For instance, a material of the light guide plate 110 may be a glass or a plastic material, or the light guide plate 110 may be a composite plate containing both the glass plate and the plastic plate. The glass may be, for example, a tempered glass being chemically processed or physically processed. The plastic material may include polymethyl methacrylate (PMMA), polycarbonate (PC), or other appropriate transparent plastic materials. Alternately, the light guide plate 110 made of a composite plate can be formed by stacking PMMA and PC. Further, in the present embodiment, a thickness of the light guide plate 110 is between 0.1 mm to 10 mm.

As shown in FIG. 1A and FIG. 1B, a light-emitting surface of the light-emitting element 120 faces a lateral surface 112 of the light guide plate 110 to provide a light beam L entering the light guide plate 110. For instance, in the present embodiment, the light-emitting element 120 may be a light-emitting diode (LED), a light amplification by the stimulated emission of radiation (LASER), a cold cathode fluorescent lamp (CCFL), an organic light-emitting diode (OLED) or other appropriate light sources. More specifically, wavelength of the light beam L provided by the light-emitting element 120 is between 350 nm to 1000 nm. In the present embodiment, the light-emitting element 120 can provide an infrared light (with a wavelength of 700 nm to 1000 nm). However, in other embodiments, the light-emitting element 120 may also provide a visible light.

More specifically, as shown in FIG. 1B, in the present embodiment, the light guide plate 110 has a plurality of lateral surfaces 112, a top surface 111 and a bottom surface 113, in which the top surface 111 and bottom surface 112 are opposite to each other and connected together by the lateral surfaces 112. The top surface 111 is an operating surface. The light guide plate 110 has a light extraction structure for a portion of the light beam L to leak from the bottom surface 113. For example, the light extraction structure can be impurities having light scattering property in the light guide plate 110. For remaining the display quality of the displayed frame, the haze of the light guide plate 110 can be smaller than 20%, preferable below 10%, but the invention is not limited thereto. Or, in order to control distribution of the light beam L being leaked, as shown in an enlarged region α of the bottom surface 113 of the light guide plate 110 depicted in FIG. 1B, the light extraction structure can be micro-structures at the bottom surface 113. The micro-structures may be a regular structure or an irregular structure. The bottom surface 113 having the micro-structures may have a surface roughness (Ra) greater than zero and less than 1 μm. Further, in other embodiments, as shown in an enlarged region β of the bottom surface 113 of the light guide plate 110 depicted in FIG. 1B, the light extraction structure may be a scattering layer disposed on the bottom surface 113. Therein, when the optical touch panel 100 is assembled with a high definition display, a haze of the scattering layer is preferably below 10%. However, in case the optical touch panel 100 is assembled with a large size display, the haze of the scattering layer may be less than 20% without influencing displaying quality thereof, but the invention is not limited thereto. The scattering layer may be a light-permeable coating having the light scattering property, or may be a diffuser attached to the bottom surface 113 through an optical adhesive (not illustrated).

The optical sensing elements 130 are disposed under the bottom surface 113 of the light guide plate 110 in a manner that is far away from the top surface 111 with respect to the bottom surface 113, and the optical sensing elements 130 are disposed within an illuminated region of the light beam L provided by the at least one light-emitting element 120. The optical sensing element 130 has a sensing surface 131, and the sensing surface 131 is not parallel to the bottom surface 113. In order to solve a problem of weak signals caused by insufficient amount of the received light due to the sensing surface 131 being overly short, while solving a problem of lower touch sensing resolution due to the sensing surface 131 being overly long, a length of the sensing surface 131 can be between 0.1 mm to 100 mm, but the invention is not limited thereto. Furthermore, in the present embodiment, the at least one light-emitting element 120 is disposed facing the lateral surface 112b, and the optical sensing elements 130 are disposed adjacent to the lateral surfaces 112a and 112d and located under the light guide plate 110. Therein, the lateral surface 112d and the light-emitting element 120 are opposite to each other. Accordingly, as shown in FIG. 1B, after the light beam L emitted from the light-emitting element 120 enters the light guide plate 110, a first portion L′ of the light beam L can travel by total internal reflection inside the light guide plate 110, and a second portion L″ of the light beam L can leave the light guide plate 110 through the bottom surface 113 and be scattered to the optical sensing elements 130.

More specifically, as shown in FIG. 1B, an included angle θ between an emission direction D1 of the second portion L″ of the light beam L and a base plane parallel to the bottom surface 113 of the light guide plate 110 is greater than zero and less than 20 degrees. Since the sensing surface 131 of the optical sensing element 130 is not parallel to the bottom surface 113, the optical sensing elements 130 can receive the second portion L″ of the light beam L leaking from the bottom surface 113. For instance, in the present embodiment, a vertical receiving angle SVF of the optical sensing element 130 may be 10 degrees. In addition, as shown in FIG. 1A, a horizontal receiving angle SHF of the optical sensing element 130 may be 150 degrees. Herein, the horizontal and the vertical receiving angles mean that the receiving angles are measured in a horizontal manner and in a vertical manner with respect to a plane of the light guide plate 110. For efficiently receiving the second portion L″ of the light beam L leaking from of the bottom surface 113, which forms an included angle with the bottom surface 113 from 0 to 20 degrees, an included angle (not illustrated) between an extending direction of the sensing surface 131 of the optical sensing element 130 and a normal direction of the bottom surface 113 is preferably within 30 degrees, but the invention not limited thereto.

FIG. 1B illustrates an embodiment in which the top surface 111 of the light guide plate 110 is not touched. In this case, the optical sensing element 130 can constantly receive the second portion L″ of the light beam L scattered from the bottom surface 113 of the light guide plate 110. On the other hand, as shown in FIG. 1C, in case the top surface 111 of the light guide plate 110 is touched by an object O (e.g., a finger), the light beam L at a contact position of the object O is scattered by the object O into a third portion L′″ of the light beam L. Now, total internal reflection of the light beam L is disturbed at the contact position of the object O, so that the third portion L′″ of the light beam L can leave the light guide plate 110 through the bottom surface 113. Therein, a traveling direction of the third portion L′″ of the light beam L leans towards the normal direction of the bottom surface 113 of the light guide plate 110, such that the third portion L′″ of the light beam L can hardly arrive to the sensing surface 131 of the optical sensing element 130. In addition, since the third portion L′″ of the light beam L is scattered by the object O to leave the light guide plate 110, namely, a part of the first portion L′ of the light beam L is forced to leave the light guide plate 110 in advance, such that an intensity of the first portion L′ (i.e., the light beam traveled inside the light guide plate 110) of the light beam L between the contact position of the object O and the sensing surface 131 of the optical sensing element 130 is decreased. Therefore, in an interval region from the contact position to the sensing surface 131, an intensity of the second portion L″ of the light beam L′ (i.e., the light beam scattered from the bottom surface 113 of the light guide plate 110) is decreased, such that a signal intensity detected by the sensing surface 131 of the optical sensing element 130 also becomes weaker. Namely, when the top surface 111 of the light guide plate 110 is touched by the object O, a signal S detected by the optical sensing element 130 corresponding to the contact position is decreased as compared to before being touched, and such a variation is known as a contact characteristic P. Therein, a trough depth of the contact characteristic P becomes greater when the object O is closer to the light-emitting element 120. In the present embodiment, the signal detected by the optical sensing element 130 is represented as in a voltage value. However, the invention is not limited thereto. Accordingly, the optical touch panel 100 can use a control processor (not illustrated) to determine a position of the object O according to a position of the optical sensing element 130 in which the signal intensity is significantly decreased (i.e. the contact characteristic), a connecting relation of the optical sensing element 130 and the light-emitting element 120, and a variation in signal intensity, so as to realize a purpose of touch detection.

In the present embodiment, the optical sensing element 130 can be a linear sensor or a sensor array, but the invention is not limited thereto. The linear sensor is composed of a plurality of sensing units, and the sensing units perform the sensing function simultaneously to obtain a continuous signal distribution, wherein a partially reduction of the continuous signal distribution corresponds to the position of the object O. The sensor array includes a plurality of sensing units arranged in an array, and a signal detected by one single sensing unit only varies in intensity instead of forming the continuous signal distribution.

FIG. 1D is a schematic view of another optical touch panel being touched by an object. Furthermore, as shown in FIG. 1D, in another embodiment, the optical sensing elements 130 are arranged closely, and a group composed of N numbers of the optical sensing element 130 performs detection at a time. In this case, based on a horizontal emission angle HF of the light-emitting element 120, the closer the object O is to the light-emitting element 120, the more the optical sensing elements 130 are affected, a continuous distribution of the signals being detected by the optical sensing elements 130 in the group is flatten while the trough depth in each signal is greater (as shown in a dash line in a signal distribution A). Otherwise, as the object O is farther from the light-emitting element 120, the continuous distribution of the signals being detected by the optical sensing elements 130 in the group is sharper while the trough depth in each signal is shallower, thereby responding to the position corresponding to the object O (as shown in a dash line in a signal distribution B).

In addition, as shown in FIG. 1A, in the present embodiment, the light guide plate 110 has a light shielding area. SA and a light transmissive area AA. The light shielding area SA is configured to shade elements or light not intended to be seen, such elements are, for example, the optical sensing elements 130. Furthermore, in other embodiments, the light shielding area SA may also include a visible pattern, such as texts, logos, decorative patterns or function keys, so as to provide effects in decorative purpose or prompting purpose. The light shielding area SA may be realized by having a light shielding layer 140 disposed on the bottom surface 133 (or the top surface 111) of the light guide plate 110. The light shielding layer 140 is made of a light shielding material, which is defined as a material deemed to render a light lost when the light passes through an interface thereof, up to and including complete opacity. The visible pattern in the light shielding area SA may be a pattern directly presented by the light shielding material or a light permeable pattern formed by patterning the light shielding layer 140 for light to pass through. Therein, the light permeable pattern can be realized by performing a local reduction to the light shielding layer 140 or forming a plurality of micro through holes in the light shielding layer 140, but the invention is not limited thereto. In addition, in order to conceal the light permeable pattern when no light source is provided, a diameter of the micro through holes may be less than 100 mm.

In order to realize maximizing of a display area of an electronic device, meet demands for narrow border, and realize maximizing of effective touch sensing area, the optical sensing element 130 may be disposed under a peripheral region of the bottom surface 113 of the light guide plate 110 to be adjacent to at least two of the lateral surfaces 112. Accordingly, the light shielding area SA may also be disposed in the peripheral region of the light guide plate 110. The light transmissive area AA may correspond to the display for the user to perform inputs and controls together with the display images.

In the present embodiment, the light shielding area SA may be disposed to surround the light transmissive area AA. As corresponding to the light shielding area SA, the light shielding layer 140 may be disposed on the entire peripheral region of the top surface 111 or the bottom surface 113 of the light guide plate 110, such that light guide plate 110 can include the light shielding area SA in a circumferential shape. However, in other embodiments, the light shielding layer 140 can also be disposed on only a portion of the peripheral region of the light guide plate 110. In case the light shielding layer 140 is disposed on the peripheral region of the bottom surface 113 of the light guide plate 110, the light shielding layer 140 may provide additional effects for the light-emitting elements 120 depending on their positions. For instance, as shown in FIG. 1B, when the light-emitting surface of the light-emitting element 120 faces the lateral surface 112 and the light beam L is infrared light, a material of the light shielding layer 140 can be a color material capable of reflecting the infrared light, so as to increase a light utilization of the light-emitting element 120. By disposing the light shielding layer 140, circuits or elements under the optical touch panel 100 can be prevented from being seen by the user, and the device can also be beautified without affecting touch functions of the optical touch panel 100. Furthermore, in the present embodiment, a light reflection layer 150 can be selectively disposed on a region of the top surface 111 of the light guide plate 110 adjacent to the light-emitting element 120. The light reflection layer 150 is capable of reflecting the light beam L and selectively absorbing light having wavelengths excluding the wavelength of the light beam L, so as to prevent the light beam L from leaking from the top surface 111. Namely, the light utilization of the light-emitting element 120 can be increased.

The optical sensing element 130 can be attached on the bottom surface 113 of the light guide plate 110 through an adhesive layer (not illustrated), or can be fixed under the bottom surface 113 through additional fixing members. The light shielding layer 140 can be disposed between the optical sensing element 130 and the bottom surface 113. In order to effectively receive the second portion L″ of the light beam L leaking from the bottom surface 113 of the light guide plate 110, a distance D between the sensing surface 131 of the optical sensing element 130 and the bottom surface 113 can satisfy: 0<D≦G tan(20°). Therein, G is a diagonal length of the top surface 111 of the light guide plate 110.

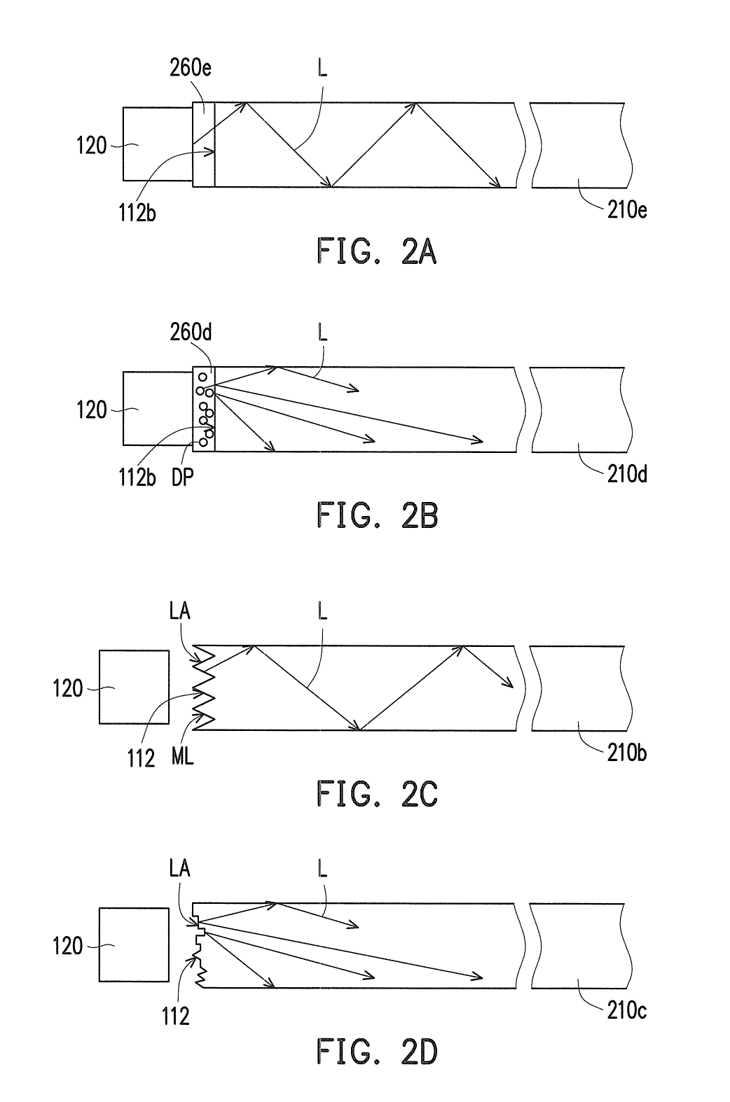

FIG. 2A to FIG. 2D are schematic side views of the light guide plate of FIG. 1A in different types. In the present embodiment, the lateral surface 112b of the light guide plate 110 can be a flat surface. Furthermore, in order to adjust distribution of the light beam L, a position of the lateral surface 112b of the light guide plate 110 corresponding to the light-emitting element 120 can be of a spherical recess or an aspherical recess (not illustrated). Since using air medium as a pathway for the light beam L before entering the light guide plate 110 will cause reduction of the light emission angle and attenuation in incident light intensity, in order to improve this problem, as shown in FIG. 2A, the light-emitting element 120 and a light incident area (refers to the lateral surface 112b in the present embodiment) of a light guide plate 210e can be coupled through an optical coupling layer 260e, so that an air intermediate is not existed between the light-emitting element 120 and the light incident area of the light guide plate 210e, but the invention is not limited thereto. A refractive index of the optical coupling layer 260e is greater than air. The optical coupling layer 260e may be a transparent optical adhesive layer. Furthermore, in order to allow the light beam L to be uniformly scattered into the light guide plate 210d, as shown in FIG. 2B, an optical coupling layer 260d may be a scattering structure layer containing scattering particles DP therein. However, in other embodiments, it is possible that the light-emitting element 120 and the light guide plate 100 as shown in FIG. 1A are not coupled through the optical adhesive. Instead, various surface treatments may be performed on the lateral surface 112 of the light guide plate 110, so that the light beam L can be uniformly scattered into the light guide plate 110. Further description regarding a structural design for the light beam L to be uniformly scattered into the light guide plate are provided below with reference to FIG. 2C and FIG. 2D, but the invention is not limited thereto.

As shown in FIG. 2C, in an embodiment, a light incident area LA of a light guide plate 210b can include a plurality of micro-structures being regularly arranged, such as microprism structures ML. The light beam L emitted from the light-emitting element 120 can be refracted by the microprism structures ML to increase a light intensity of the light beam L entering the light guide plate 210b. As shown in FIG. 2D, in another embodiment, the light incident area LA of a light guide plate 210c can include a plurality of micro-structures being irregularly arranged, such as a rough surface. Accordingly, the light beam L can also be scattered into the light guide plate 210c to increase the light intensity of the light beam L entering the light guide plate 210c.

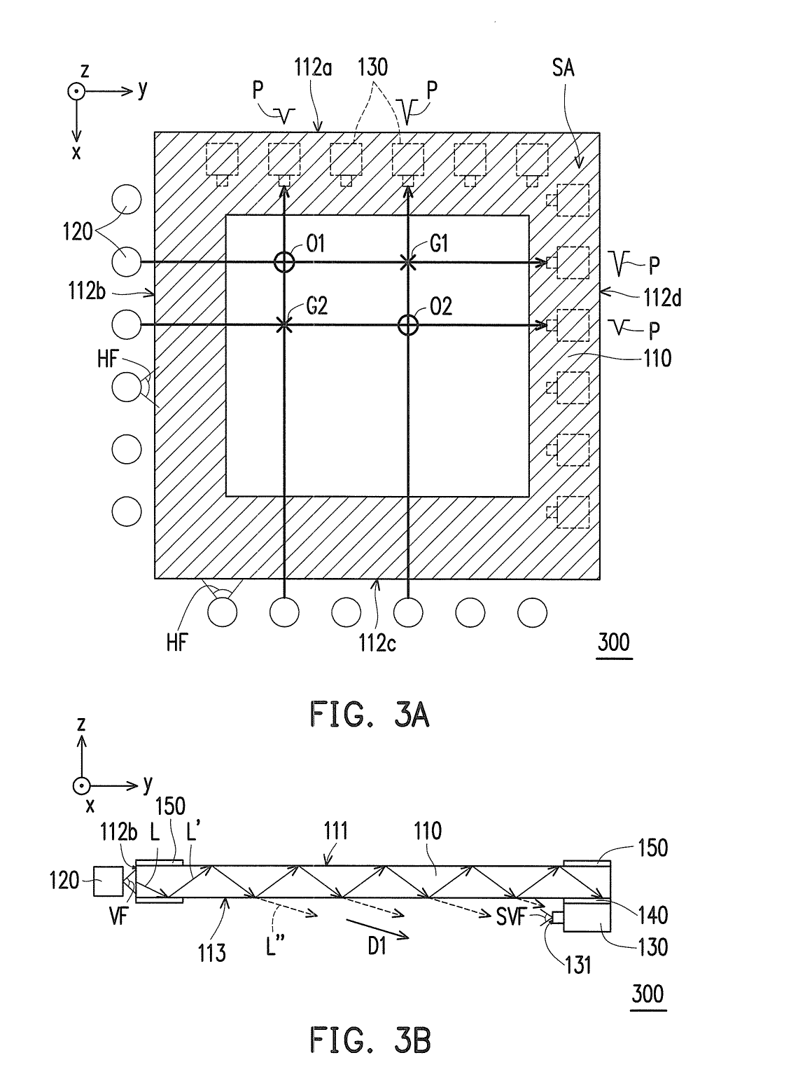

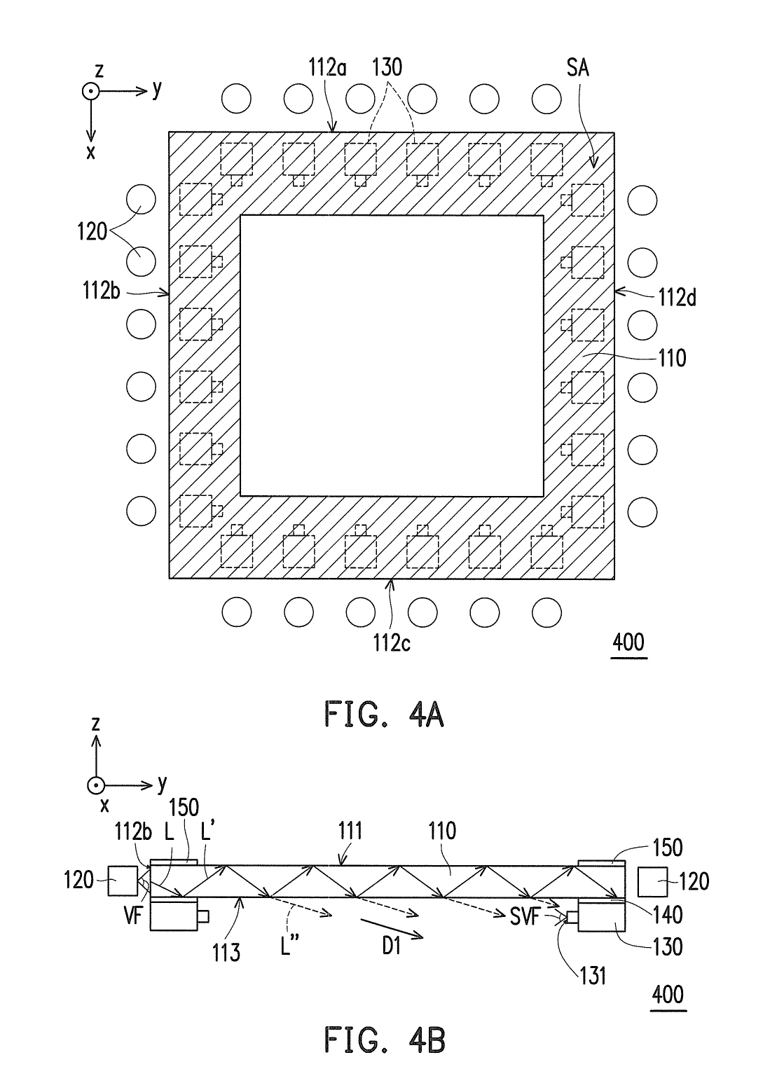

Further, despite that it is illustrated with the amount of the light-emitting element 120 being one as an example in foregoing embodiments, but the invention is not limited thereto. In other embodiments, the amount of the light-emitting element 120 can also be plural, so as to realize a multi-touch detection or a high resolution detection. Further description regarding configurations of the light-emitting element 120 and the optical sensing element 130 for different conditions are described below with reference to FIG. 3A to FIG. 4B.

FIG. 3A is a schematic top view of an optical touch panel according to another embodiment of the invention. FIG. 3B is a schematic side view of the optical touch panel depicted in FIG. 3A. Referring to FIG. 3A and FIG. 3B, in the present embodiment, an optical touch panel 300 of FIG. 3A is similar to the optical touch panel 100 of FIG. 1A, and a difference thereof is described below. As shown in FIG. 3A, in the present embodiment, the number of the light-emitting element 120 is plural. The light-emitting elements 120 face two adjacent lateral surfaces 112b and 112c of the light guide plate 110. The optical sensing elements 130 are disposed under the bottom surface 113 of the light guide plate 110 and closing to another two adjacent lateral surfaces 112a and 112d that are opposite to the lateral surfaces 112b and 112c facing the light-emitting elements 120. The optical sensing elements 130 can be concealed by the light shielding layer 140 disposed on the bottom surface 113 of the light guide plate 110. Accordingly, as shown in FIG. 3B, a first portion L′ of the light beam L emitted from each of the light-emitting elements 120 travels by total internal reflection inside the light guide plate 110, and a second portion L″ of the light beam L is scattered through the bottom surface 113 to the sensing surface 131 of the optical sensing element 130 located at the opposite side. Principles for the optical touch panel 300 to detect the coordinate of the contact position is similar to that of the optical touch panel 100, thus related description is omitted hereinafter. In the present embodiment, the light beam L provided by the light-emitting element 120 has a horizontal emission angle HF (light beam angle measured in a direction parallel to the top surface 111 of the light guide plate 110) less than a vertical emission angle VF. For instance, the light beam L provided by the light-emitting element 120 has the horizontal emission angle HF being approximately 10 degrees, and the vertical light beam angle VF being approximately 150 degrees. Accordingly, transmission of the light beam L in the light guide plate 110 is ensured, which helps increasing a touch sensing resolution (since a waveform of the signal can be significantly dropped in responding to the contact position), but the invention is not limited thereto.

Based on the foregoing embodiments, the contact position of the object O can be accurately obtained through an intersection of connections between the two optical sensing elements 130 outputting the contact characteristic P and the corresponding light-emitting elements 120. However, in a multi-touch mode, for example, when an object O1 and an object O2 simultaneously touch on the optical touch panel 300, connections between the optical sensing elements 130 outputting the contact characteristic P and the corresponding light-emitting elements 120 may result in four intersections O1, O2, G1 and G2. In this case, based on the principle in which the trough depth of the contact characteristic P becomes greater when the object O is closer to the light-emitting element 120, ghost points G1 and G2 are excluded.

Based on foregoing embodiments, in case the contact position of the object O is very close to one of the optical sensing elements 130, since the amount of the second portion L″ of the light beam L decreased by the object O is overly less, the optical sensing element 130 cannot easily sense the variation in the attenuation of the signal, thereby limiting an effective touch sensing area of the touch panel. Therefore, another embodiment is further disclosed below to solve above-said problem.

FIG. 4A is a schematic top view of an optical touch panel according to yet another embodiment of the invention. FIG. 4B is a schematic side view of the optical touch panel depicted in FIG. 4A. Referring to FIG. 4A and FIG. 4B, in the present embodiment, an optical touch panel 400 of FIG. 4A is similar to the optical touch panel 300 of FIG. 3A, and a difference thereof is described below. More specifically, in the present embodiment, the optical sensing elements 130 are arranged under the peripheral region of the bottom surface 113 of the light guide plate 110, and concealed by the light shielding layer 140 disposed on the bottom surface 113 of the light guide plate 110. The light-emitting elements 120 are disposed around and face the lateral surfaces 112 of the light guide plate 110. Accordingly, as shown in FIG. 4B, a first portion L′ of the light beam L emitted from each of the light-emitting elements 120 travels by total internal reflection inside the light guide plate 110, and a second portion L″ of the light beam L is scattered through the bottom surface 113 to the sensing surface 131 of the optical sensing element 130 located at the opposite side. In other words, an optical touch panel 400 can achieve similar functions, effects and advantages of the optical touch panel 300 by disposing one of the light-emitting elements 120, and the optical sensing element 130 at opposite side, thus related description thereof is omitted hereinafter.

Based on the present embodiment, each of the optical sensing elements 130 is disposed with another one of the optical sensing elements 130 at the opposite side, and each of the light-emitting elements 120 is also disposed with another one of the light-emitting elements 120 at the opposite side. Accordingly, in case the contact position of the object O is very close to one of the optical sensing elements 130, the optical touch panel 400 can still detect the amount of the second portion L″ of the light beam L decreased by the contact of the object O through the another one of the optical sensing elements 130 at the opposite side, so that the optical touch panel 400 can achieve a more accurate touch detection, and the effective touch sensing area of the optical touch panel 400 can also be increased.

On the other hand, despite that the optical touch panels 300 and 400 are illustrated as structures having the light guide plate 110 as examples, the light guide plates 210b, 210c, 210d and 210e can also be selected to increase the light intensity of the light beam L entering the light guide plate, and detailed description thereof can refer to foregoing paragraphs, thus it is omitted hereinafter.

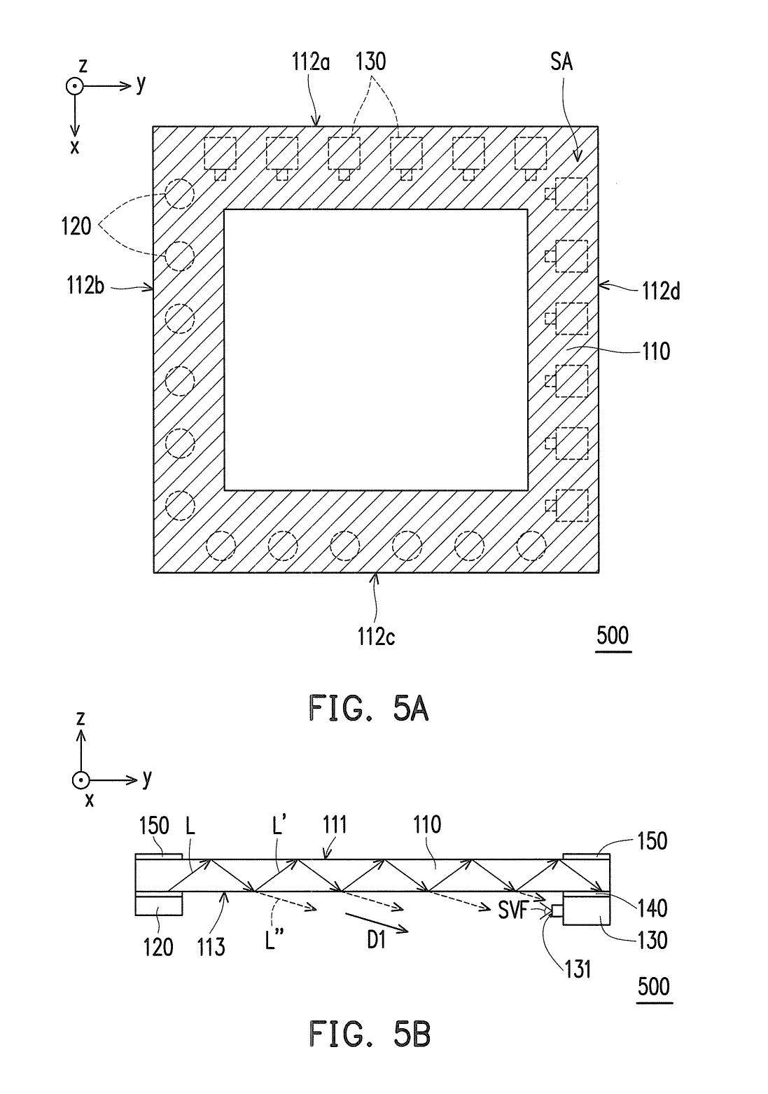

Further, despite that it is illustrated with the light-emitting element 120 facing to at least one of the lateral surfaces 112 as an example in foregoing embodiments, but the invention is not limited thereto. In other embodiments, the light-emitting element 120 can also face the bottom surface 113, and related description is further described below with reference to FIG. 5A to FIG. 8B.

FIG. 5A is a schematic top view of an optical touch panel according to still another embodiment of the invention. FIG. 5B is a schematic side view of the optical touch panel depicted in FIG. 5A. Referring to FIG. 5A and FIG. 5B, in the present embodiment, an optical touch panel 500 of FIG. 5A is similar to the optical touch panel 300 of FIG. 3A, and a difference thereof is described below. As shown in FIG. 5A, in the present embodiment, the light-emitting elements 120 face the bottom surface 113 of the light guide plate 110, and the light-emitting elements 120 and the optical sensing element 130 are adjacent to different ones of the lateral surfaces 112 of the light guide plate 110. Each of the optical sensing elements 130 is opposite to one of the light-emitting elements 120. The light shielding layer 140 is a color material incapable of absorbing the infrared light (i.e., allowing the infrared light to pass), or other appropriate materials capable of scattering the infrared light and absorbing the visible light from the outside. In case the light-emitting elements 120 provide visible light, the light source required by the light permeable pattern in the light shielding area SA can be provided by the light-emitting elements 120. The light-emitting elements 120 and the optical sensing elements 130 can both be concealed by the light shielding layer 140 disposed on the bottom surface 113 of the light guide plate 110. As shown in FIG. 5B, a first portion L′ of the light beam L emitted from each of the light-emitting elements 120 travels by total internal reflection inside the light guide plate 110, and a second portion L″ of the light beam L is scattered through the bottom surface 113 to the sensing surface 131 of the optical sensing element 130 located at the opposite side. Principles for the optical touch panel 500 to detect the coordinate of the contact position is similar to that of the optical touch panels 100 and 300, thus related description is omitted hereinafter.

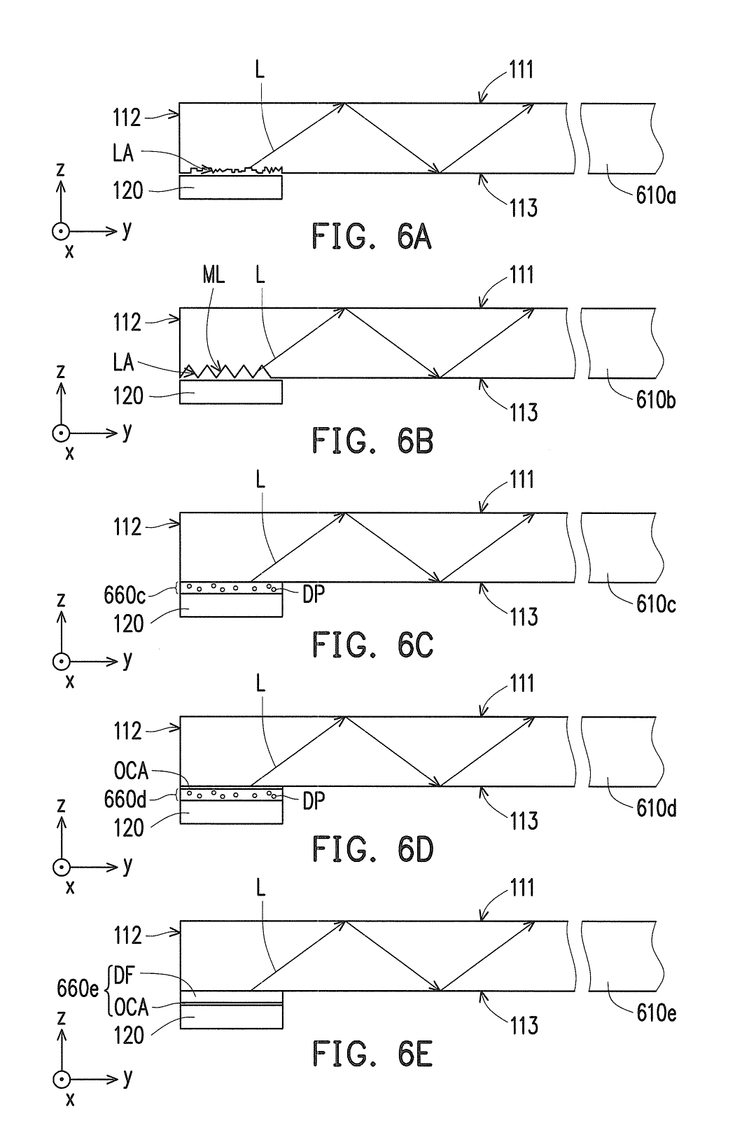

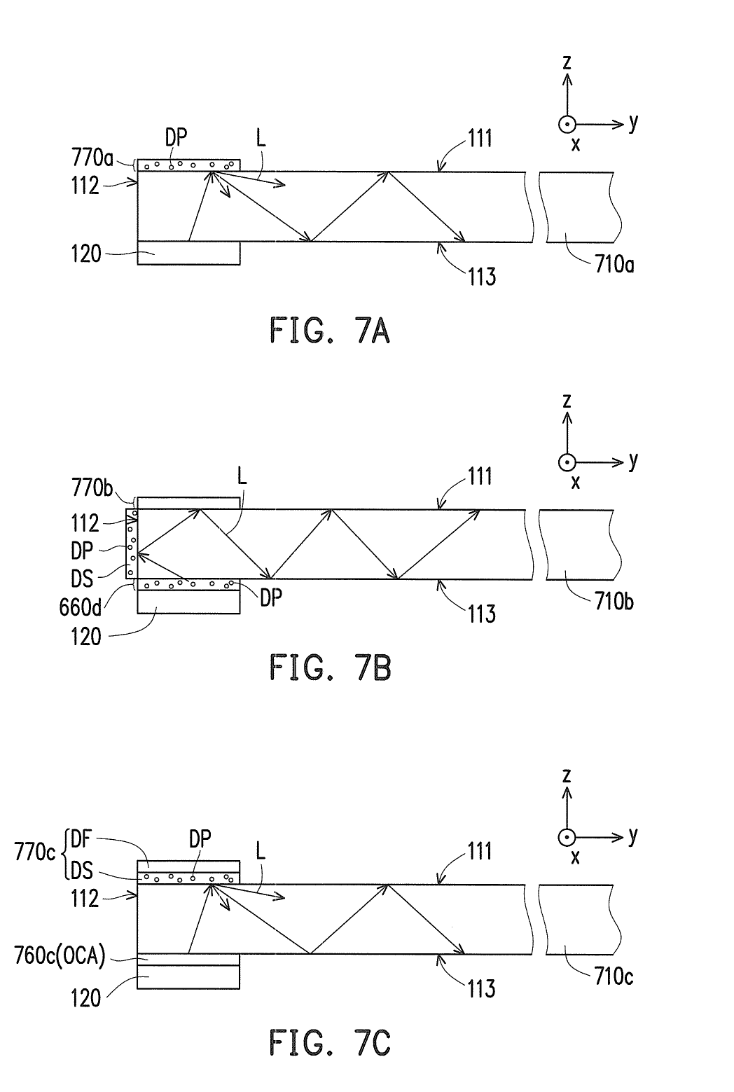

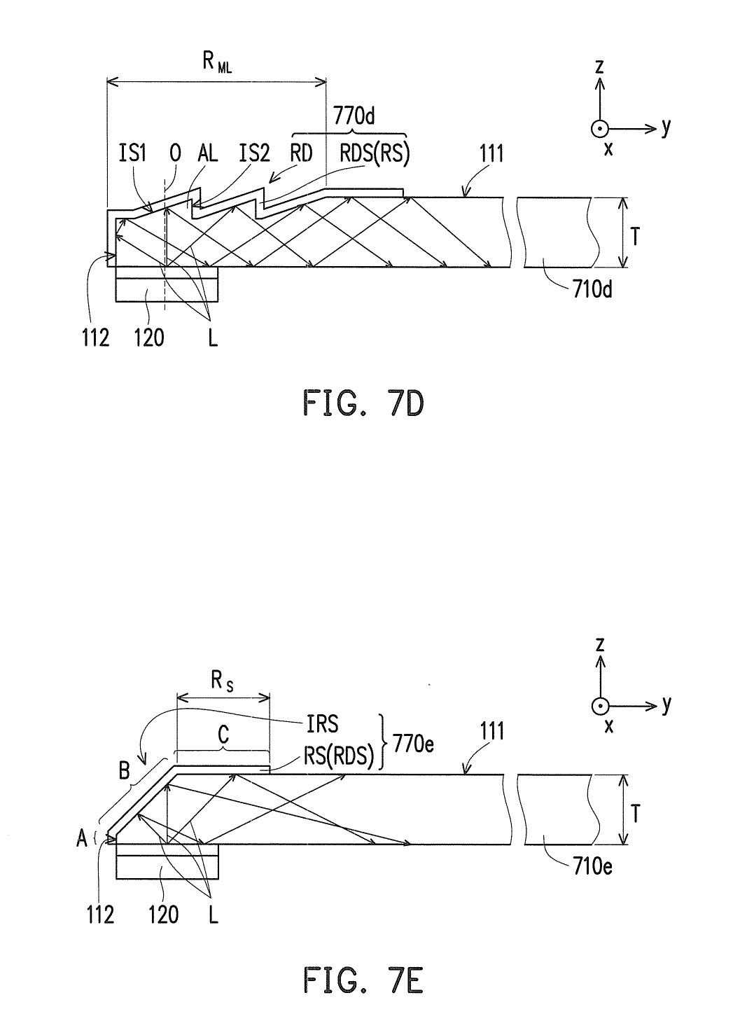

Further, in the present embodiment, despite that it is illustrated with the light-emitting element 500 having the light guide plate 110 as an example, but the invention is not limited thereto. Instead, various surface treatments can be performed on the top surface 111, the bottom surface 113 or the lateral surfaces 112 of the light guide plate 110 for the optical touch panel 500, so that the light beam L can be uniformly scattered into the light guide plate 110. Related description to the above are provide below with reference to FIG. 6A to FIG. 7C.

FIG. 6A to FIG. 6E are schematic side views of the light guide plate of FIG. 5A in different types. FIG. 7A to FIG. 7C are schematic side views of light guide plate of FIG. 5A in different types. Referring to FIG. 6A, in the present embodiment, the light incident area LA at the bottom surface 113 of the light guide plate 610a facing the light-emitting element 120 may be a rough surfaces, so that the light beam L provided by the light-emitting element 120 can be scattered into the light guide plate 610a and the effect of coupling the light beam L into the light guide plate 610a can also be achieved, but the invention is not limited thereto.

For instance, as shown in FIG. 6B, in an embodiment, the light incident area LA at the bottom surface 113 of the light guide plate 610b facing the light-emitting element 120 can include a plurality of microprism structures ML being regularly arranged. The light beam L emitted from the light-emitting element 120 can be refracted by the microprism structures ML to increase the light intensity of the light beam L entering the light guide plate 610b, but the invention is not limited thereto.

Furthermore, as shown in FIG. 6C, in order to prevent reduction of light emission angle and attenuation in amount of incident light caused by transmission of the light beam L through an air medium before entering the light guide plate 110, the light-emitting element 120 and the light incident area (refers to the bottom surface 113 in the present embodiment) of a light guide plate 610c can be coupled through an optical coupling layer 660c. The optical coupling layer 660c can be a scattering structure layer containing the scattering particles DP therein, so that the light beam L can be uniformly scattered into the light guide plate 610c and the light amount of the light beam L entering the light guide plate 610c can also be increased, but the invention is not limited thereto.

On the other hand, in an other embodiment, as shown in FIG. 6D, an optical coupling layer 660d can also be a combination of an optical adhesive layer OCA and a scattering structure layer having the scattering particles DP, and the light intensity of the light beam L entering a light guide plate 610d can be increased by selecting a refractive index of the optical adhesive layer OCA. In addition, as shown in FIG. 6E, in an embodiment, an optical coupling layer 660e can also be a combination of the optical adhesive layer OCA and a diffuser DF. In the present embodiment, the diffuser DF can be a material capable of scattering the infrared light and absorbing the visible light. Accordingly, the amount of the infrared light entering the light guide plate 610e can be increased.

In addition, as shown in FIG. 7A to FIG. 7C, in other embodiments, the optical touch panel 500 may further include a first optical structure 770 disposed in a periphery region of the light guide plate 710a, 710b, 710c, 710d, and 710e excluding the bottom surface 113 and opposite to the light-emitting surface of the light-emitting element 120. For instance, as shown in FIG. 7A, in an embodiment, the first optical structure 770a may be a scattering structure layer disposed on the periphery region of the top surface 111, in which the scattering structure layer includes a plurality of scattering particles DP therein. The light beam L in the light guide plate 710a can be scattered by the first optical structure 770a and back to the light guide plate 710a, so as to increase the light intensity of the light beam L traveled inside the light guide plate 710a, but the invention is not limited thereto. As shown in FIG. 7B, in another embodiment, the first optical structure 770b may be a specular reflection layer disposed on the periphery region of the top surface 111. The light beam L in the light guide plate 710b can be reflected by the first optical structure 770b, so as to prevent leaking from the top surface 110 to further increase the light utilization of the light-emitting element 120.

Furthermore, as shown in FIG. 7D and FIG. 7E, in an alternative embodiment, the first optical structure 770d of the optical touch panel 500 can also include a reflection structure RD. Specifically, the reflection structure RD can be implemented by forming microstructures (as shown in FIG. 7D) at the periphery of the top surface 111 of the light guide plate 710d, by disposing the reflection oblique surfaces (as shown in FIG. 7E) between the top surface 111 and the lateral surfaces 112 of the light guide plate 770e, or by a combination of the above means. In an example, the reflection structure RD includes a plurality of asymmetrical prisms AL, each of which includes a first oblique surface IS1 and a second oblique surface IS2. An included angle between the first oblique surface IS1 and the second oblique surface IS2 is smaller than 180 degrees. The first oblique surface IS1 is closer to the lateral surfaces 112 than the second oblique surface IS2 is, and a length of the first oblique surface IS1 is greater than that of the second oblique surface IS2. In the present embodiment, the closer the first oblique surface IS1 to the second oblique surface IS2, the farther the first oblique surface IS1 away from the bottom surface 113 of the light guide plate 710e. Through the asymmetrical prisms AL, the light beam L is reflected at the first oblique surface IS1 to travel farther away from the optical axis O of the light emitting element 120, such that the amount of the light beam L transmitted inside the light guide plate 710d is increased. In addition, the reflection structure RD in the present embodiment satisfies a condition: R_{ML}>2*T*tan(sin⁻¹(1/n)), in which R_{ML} is an extending length of the reflection structure RD extending outwardly from the lateral surfaces 112, T is a thickness of the light guide plate 710d, and n is a refractive index of the light guide plate 710d.

As such, the disposition area of the reflection structure RD can be defined so that a portion of the light beams L from the light emitting element 120 having an included angle with respect to the optical axis O that is smaller than the critical angle of total inner reflection can be reflected by the first oblique surface IS1 of the reflection structure RD, so as to increase the amount of the light beam L transmitted inside the light guide plate 710d.

Furthermore, in the present embodiment, the first optical structure 770d further includes a scattering structure layer RDS or a specular reflection layer RS, that is, the first optical structure 770d is formed by a combination of the scattering structure layer RDS (or the specular reflection layer RS) and the reflection structure RD. The physical design of the scattering structure layer RDS and the specular reflection layer RS can be referred to the description of FIG. 7A to FIG. 7C. More specifically, the scattering structure layer RDS (or the specular reflection layer RS) is disposed on the reflection structure RD. For example, in the embodiment, the scattering structure layer RDS is an optical adhesive layer with diffusing particles therein.

Alternatively, as shown in FIG. 7E, the reflection structure of the optical touch panel 500 can be a reflection oblique surface IRS located between the top surface 111 and the lateral surfaces 112 of the light guide plate 710e. An included angle between the reflection oblique surface IRS and the lateral surfaces 112 is not smaller than 135 degrees and not greater than 179 degrees. In addition, the optical touch panel 500 of the present embodiment further includes a specular reflection layer RS or a scattering structure layer RDS which is disposed on a partial region (the region C) of the top surface 111 of the light guide plate 710e and the reflection oblique surface IRS. Optionally, the specular reflection layer RS or the scattering structure layer RDS can further extend to be disposed on the region A of the lateral surfaces 112. In FIG. 7E, the light beam L entering the light guide plate 710e can be reflected or scattered by the first optical structure 770e and remain travelling inside the light guide plate 710e. In the present embodiment, the width R_{S} of the partial region (region C) of the top surface 111 disposed with the specular reflection layer RS or the scattering structure layer RDS satisfies a condition: R_{S}≧T*tan(sin⁻¹(1/n)), in which R_{S} is a width of the partial region of the top surface 111, T is a thickness of the light guide plate 710e, and n is a refractive index of the light guide plate 710e.

In addition, based on actual requirements, person skilled in the art may combine uses of the optical coupling layers 660c, 660d, 660e and the first optical structures 770a, 770b, 770d, 770e to increase both the light utilization of the light-emitting element 120 and a uniformity of light beam L distributed inside the light guide plate. For instance, as shown in FIG. 7C, the first optical structure 770c can include a scattering structure layer DS and a diffuser DF capable of scattering the infrared light and absorbing the visible light, and an optical coupling layer 760c can be the optical adhesive layer OCA used to increase the light amount of the light beam L entered the light guide plate 710c.

On the other hand, it should be noted that, in the embodiments of FIG. 6A through FIG. 7E, one of the lateral surfaces 112 adjacent to the light-emitting element 120 can be a rough surface or a mirror surface, but the invention is not limited thereto. For instance, in the embodiment of FIG. 7B, the optical touch panel 500 can further include the scattering structure layer DS containing the scattering particles DS therein and disposed on the lateral surface 112 adjacent to at least one light-emitting element 120, thereby increasing the light utilization of the light-emitting element 120.

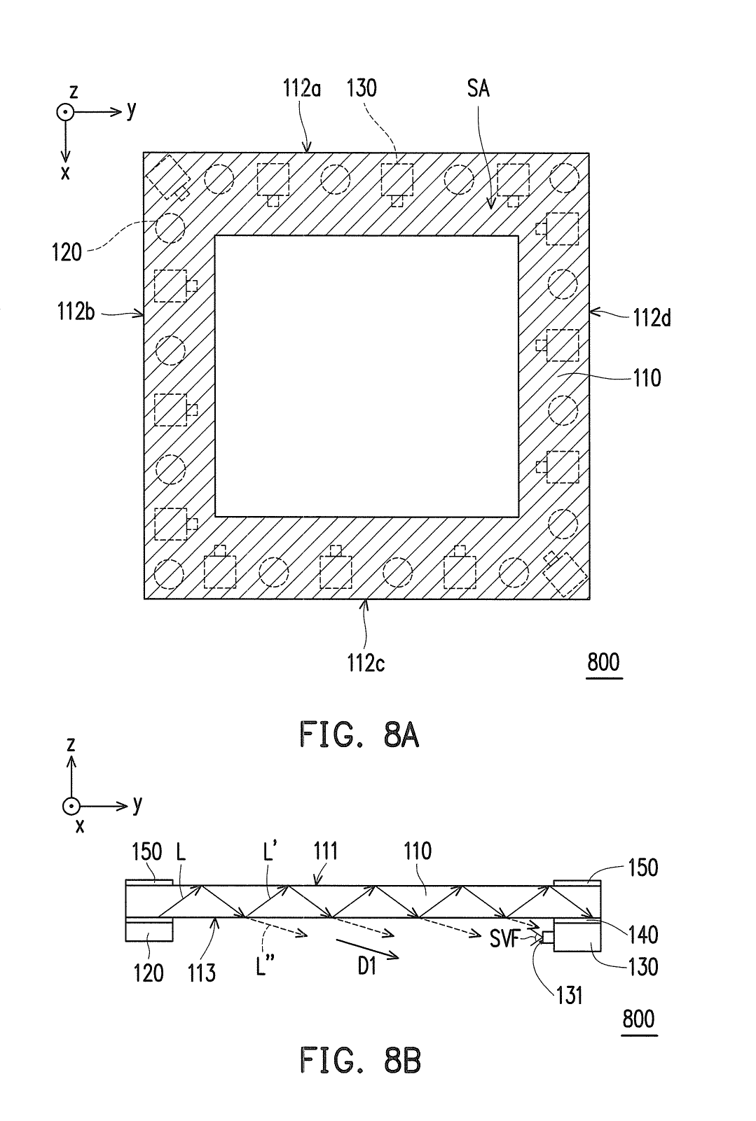

FIG. 8A is a schematic top view of an optical touch panel according to yet another embodiment of the invention. FIG. 8B is a schematic side view of the optical touch panel depicted in FIG. 8A. In the present embodiment, an optical touch panel 800 of FIG. 8A is similar to the optical touch panel 500 of FIG. 5A, and a difference thereof is described below. As shown in FIG. 8A, in the present embodiment, the light-emitting elements 120 face the peripheral region of the bottom surface 113 of the light guide plate 110. The optical sensing elements 130 and the light-emitting elements 120 are alternately arranged, and each of the optical sensing elements 130 is disposed opposite to each of the light-emitting elements 120. The optical sensing elements 130 are disposed under the bottom surface 113 of the light guide plate 110, and the optical sensing element 130 and the light-emitting element 120 can be concealed by the light shielding layer 140 disposed on the bottom surface 113 of the light guide plate 110. Accordingly, as shown in FIG. 8B, a first portion L′ of the light beam L emitted from each of the light-emitting elements 120 travels by total internal reflection inside the light guide plate 110, and a second portion L″ of the light beam L is scattered through the bottom surface 113 to the sensing surface 131 of the optical sensing element 130 located at the opposite side. In other words, an optical touch panel 800 can achieve similar functions, effects and advantages of the optical touch panel 500 by disposing one of the light-emitting elements 120, and the optical sensing element 130 at opposite side, thus related description thereof is omitted hereinafter.

On the other hand, in the present embodiment, in case the contact position of the object O is very close to one of the optical sensing elements 130, by having the optical sensing elements 130 and the light-emitting elements 120 alternately arranged in high density and a timing scanning method, the optical sensing element 800 can still detect the amount of the second portion L″ of the light beam L decreased by the object O through the optical sensing elements 130 adjacent to the light-emitting element 120 opposite to one of the optical sensing elements 130. Accordingly, effects and advantages as mentioned in description for the optical touch panel 400 can be achieved, thus related description is omitted hereinafter for it can refer to the foregoing paragraph. On the other hand, despite that the optical touch panel 800 is illustrated as a structure having the light guide plate 110 as examples, but the optical touch panel 800 can also be disposed with any light guide plate in FIG. 6A to FIG. 7E to increase the light utilization of the light-emitting element 120 and the light amount of the light beam L entering the light guide plate, and detailed description thereof can refer to foregoing paragraphs, thus it is omitted hereinafter.

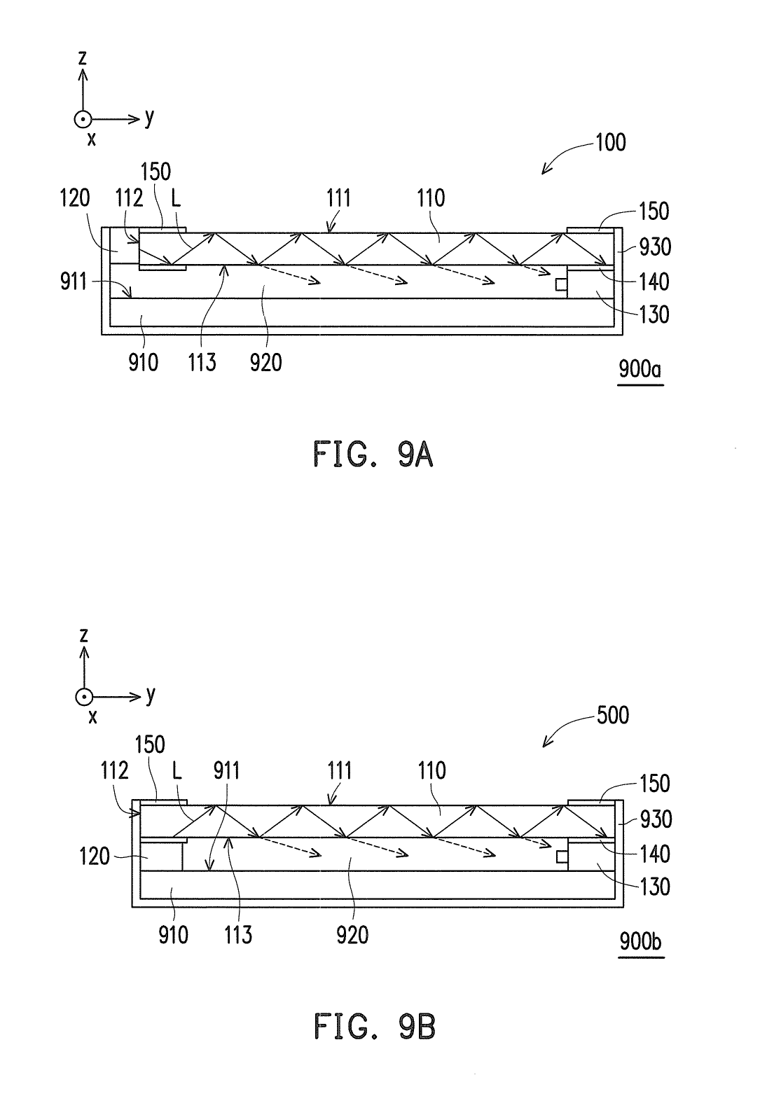

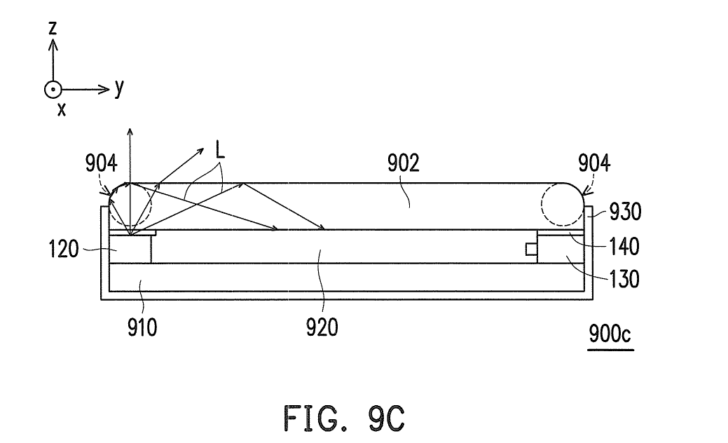

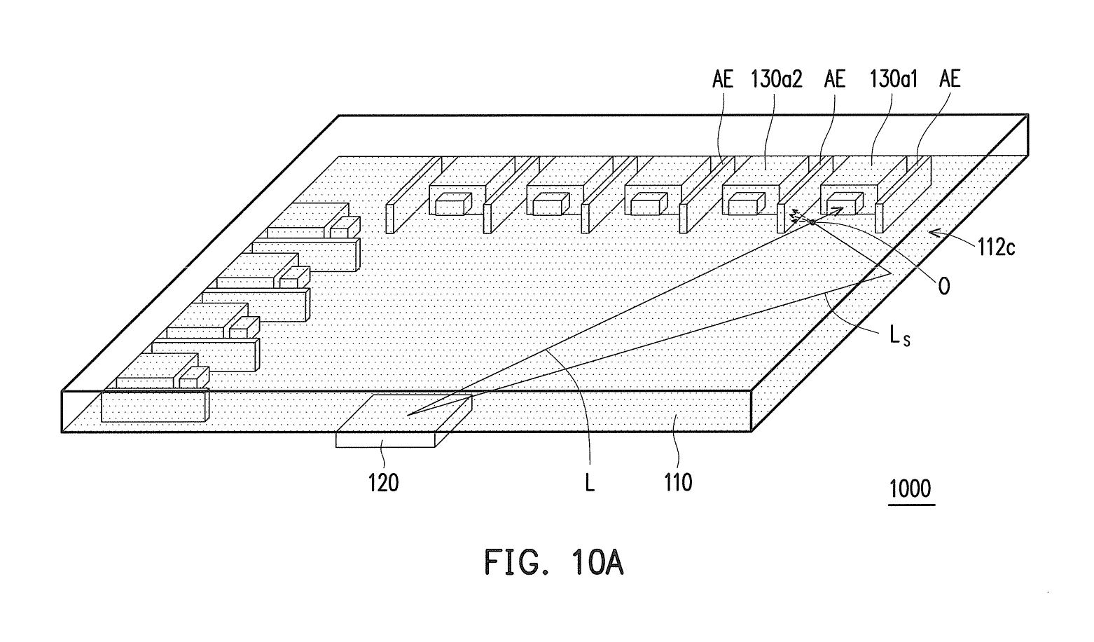

FIG. 9A is a schematic side view of a touchscreen according to an embodiment of the invention. Referring to FIG. 9A, in the present embodiment, a touchscreen 900a includes a display 910 and one of the above-mentioned optical touch panels 100, 300, and 400. The display 910 has a display surface 911. The button surface 113 of the light guide plate 110 of the optical touch panel 100 faces the display surface 911 of the display 910. For instance, in the present embodiment, the display 910 can be a self-luminance display such as an organic electroluminescent display, a plasma display or a field emission display, or a non self-luminance display such as a liquid crystal display, an electrowetting display or an electrophoretic display. On the other hand, as shown in FIG. 9A, in the present embodiment, a touchscreen 900a further includes a medium layer 920 between the display surface 911 and the bottom surface 113 of the light guide plate 110, and a refractive index of the medium layer 920 is lower than a refractive index of the light guide plate 110. Accordingly, a displaying light beam emitted from the display 910 is less likely to generate an intensive interface reflection at the bottom surface 113 of the light guide plate 100, so as to achieve favorable display functionality.

FIG. 9B is a schematic side view of a touchscreen according to another embodiment of the invention. Referring to FIG. 9B, in the present embodiment, a touchscreen 900b of FIG. 9B is similar to the touchscreen 900a of FIG. 9A, and a difference thereof is described below. In the embodiment of FIG. 9A, the light-emitting element 120 of the touchscreen 900a faces the lateral surface 112 of the light guide plate 110. In the embodiment of FIG. 9B, the light-emitting element 120 of the touchscreen 900b faces the bottom surface 113 of the light guide plate 110.

In order to achieve the substantially flat operating surfaces of the touchscreen 900a and 900b so that the touchscreen 900a and 900b have the full flat surface structure, in the embodiment of FIG. 9A, a portion of a frame 930 covers the light-emitting element 120 and substantially has the same elevation as the top surface 111 of the light guide plate 110. Or, the light guide plate 110 can include an accommodating recess (not illustrated) to accommodate the light-emitting element 120, and the light shielding layer can be filled into the accommodating recess, or the light shielding layer can be disposed on the top surface 111 of the light guide plate 110, so as to cover the light-emitting element 120.

In view of above, in the embodiment of FIG. 9B, since both the optical sensing element 130 and the light-emitting element 120 of the touchscreen 900b are not higher than a horizontal height (an elevation) of the top surface 111 of the light guide plate 110, thus the frame 930 of the touchscreen 900a and 900b can substantially have the same elevation as the top surface 111 of the light guide plate 110, so as prevent a height gap caused by the frame 930 covering the top surface 111 of the light guide plate 110. Accordingly, the touchscreen 900b can have the full flat surface structure for better appearance, and the problem of sticking dirt derived from the height gap caused by the frame 930 on the operating surface can also be solved.

Furthermore, it should be noted that, despite that the touchscreen 900a and 900b of the present embodiment are illustrated by including the optical touch panel 100 depicted in FIG. 1A or the optical touch panel 500 depicted in FIG. 5A as examples, but the invention is not limited thereto. In other embodiments, the optical touch panel included in the touchscreen 900b can also be any one among the optical touch panels 500 and 800 as disclosed in the embodiments of FIG. 5A and FIG. 8A, which all include the effect and advantage as mentioned previously, thus related description is omitted hereinafter. In addition, structural designs and configurations for the optical touch panels 100, 300, 400, 500 and 800 can refer to related paragraph in the foregoing embodiments, thus they are omitted hereinafter.

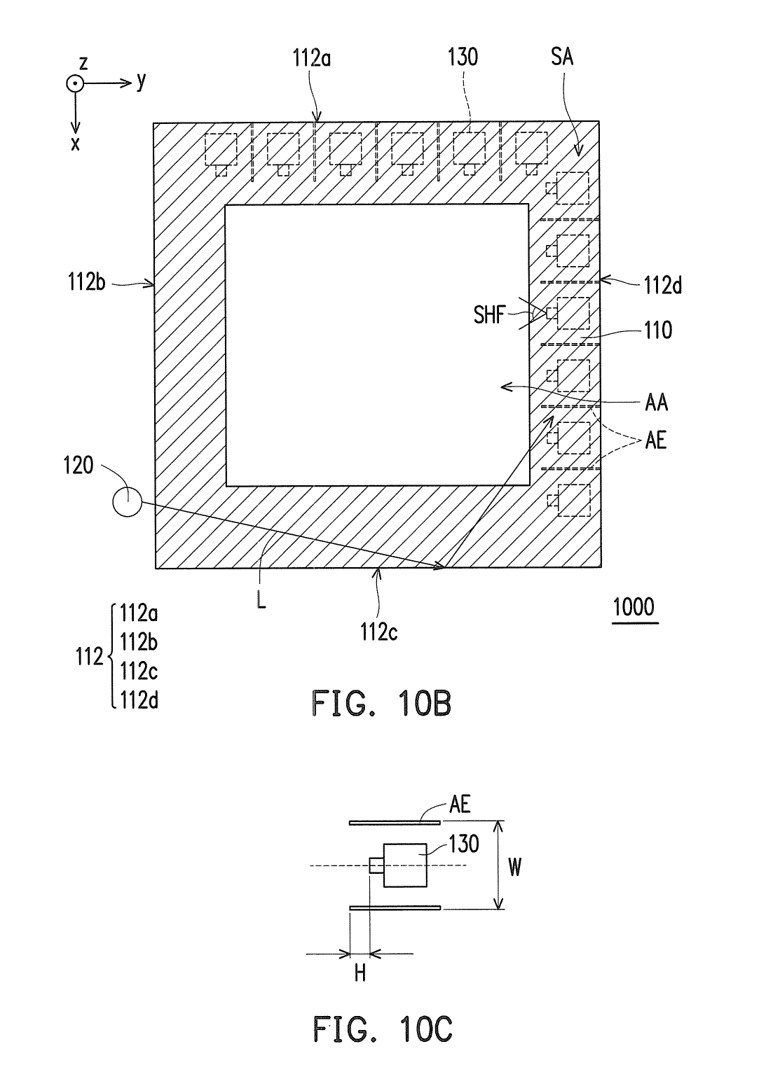

FIG. 10A is a schematic perspective view of an optical touch panel according to further another embodiment of the invention. FIG. 10B is a schematic top view of the optical touch panel depicted in FIG. 10A. FIG. 10C shows the disposition relationship of the optical absorbing element and the optical sensing element depicted in FIG. 10A. Referring to FIG. 10A and FIG. 10B, the optical touch panel 1000 in FIG. 10A is similar to the optical touch panel 100 in FIG. 1 and the difference therebetween is described in the following. The optical touch panel 1000 further includes a plurality of optical absorbing elements AE respectively disposed between adjacent two of the optical sensing elements 130.

Specifically, the optical absorbing elements AE shown in FIG. 10A can absorb the light beam L_{S} reflected by the lateral surface 112c of the light guide plate 110 so as to restrain the interference caused by the light beam L_{S} reflected under the total reflection effect at the lateral surfaces 112. For example, without disposing the optical absorbing elements AE, when the point O of the light guide plate 110 is touched by an object, the optical sensing element 130a1 will detect a reduction of the amount of leaked light from the light beam L, while the optical sensing element 130a2b may also detect a reduction of the amount of leaked light form the light beam L_{S}. Therefore, the optical sensing element 130a2b may generate a contact characteristic and a ghost point may generate. Therefore, the angle of the incident light can be restricted by disposing the optical absorbing element AE so as to reduce the interference of the signals and be helpful to the coordinate calculation.

In addition, referring to FIG. 10C, the optical touch panel 1000 satisfies a condition: (W/H)<2*tan(90°−sin⁻¹(1/n)), in which W is a pitch of the adjacent two of the optical absorbing elements AE, H is a distance from a projection of a center of the sensing surface 131 of the optical sensing element 130 on the optical absorbing element AE to a tip of the optical absorbing element AE, and n is a refractive index of the light guide plate 110. In addition, the optical touch panel 1000 can achieve similar functions of the optical touch panel 100 by disposing the light emitting elements 120 and the optical sensing elements 120 opposite thereto, in which the similar function and characteristics are not repeated herein.

Based on above, in the optical touch panel of the invention, the first portion of the light beam provided by the light-emitting element can travel by total internal reflection inside the light guide plate, and the second portion of the light beam can be scattered into the optical sensing element through the bottom surface of the light guide plate, so as to realize the purpose of touch sensing. The optical sensing element can be disposed more closely to the bottom surface of the light guide plate since the included angle θ between the emission direction of the second portion and the base plane of the light guide plate is very small, so as to reduce an overall thickness thereof. Moreover, the optical sensing element can perform the sensing function without being influenced by external light sources since the sensing surface of the optical sensing element are disposed as not parallel to the bottom surface of the light guide plate. Therefore, the invention can provide a more preferable effect for avoiding interferences. In other hand, various surface treatments can be performed on the top surface, the bottom surface and the lateral surfaces of the light guide plate, so that the light beam provided by the light-emitting element can be uniformly scattered into the light guide plate to achieve the effect of increasing the light utilization of the light-emitting element. In addition, in the optical touch panel and the touchscreen of the invention, by disposing the optical sensing element under the bottom surface of the light guide plate to detect the light beam leaked from the bottom surface of the light guide plate, the requirements of the full flat surface device are satisfied.

In all of the foregoing embodiments, a material of the light guide plate may be a glass plate, a plastic plate, a composite plate containing both the glass plate and the plastic plate. The glass may be, for example, a tempered glass being chemically processed or physically processed. The plastic material may be polymethyl methacrylate (PMMA), polycarbonate (PC), Poly(ethylene tetraphthalate) (PET) or other appropriate transparent materials. The light guide plate can also be a composite plate formed by stacking at least two different materials, such as a light guide plate formed by stacking a PMMA layer and a PC layer. A thickness of the light guide plate is between 0.1 mm to 10 mm. In the light guide plate made of plastic material, an anti-scratch layer may be selectively coated or plated on the surfaces. Besides serving as a light transmission medium, the light guide plate can also include functions of a cover lens to serve as a protective cover for the display and a full flat touch surface for the electronic product.

FIG. 9C is a schematic side view of a touchscreen according to another embodiment of the invention. Referring to FIG. 9C, in the present embodiment, a touchscreen 900c of FIG. 9C is similar to the touchscreen 900b of FIG. 9B, and a difference thereof is described below. The lateral surfaces 904 of the light guide plate 902 may further have arc shape portions connecting to the top surface, for example, the light guide plate 902 can be a 2.5D cover lens. Together with the light-emitting surface of the light-emitting element facing the bottom surface of the light guide plate as shown in FIG. 9C, such that more of the light beam can travel by total internal reflection inside the cover lens to provide more preferable light utilization. It is more preferable that an included angle between the sensing surface of the optical sensing elements 130 and a vertical axis of the bottom surface of the light guide plate is within 30 degrees, but the invention is not limited thereto. The light extraction structure can either be micro-structures with artificial design or natural micro-structures without artificial design, as long as the light beam can leave the bottom surface of the light guide plate through the micro-structures. For instance, the bottom surface of a common glass substrate is smooth in terms of macroscopic, but in terms of microscopic, it has irregular natural micro-structures in nanoscale. Therefore, it falls within the scope of the invention as long as a surface roughness (Ra) is greater than zero and less than 1 μm.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. An optical touch panel, comprising:
a light guide plate having a plurality of lateral surfaces, a top surface, a bottom surface opposite to the top surface and a light extraction structure, and the top surface and the bottom surface connected together by the lateral surfaces;
at least one light-emitting element having a light-emitting surface, and the light-emitting element providing a light beam entering the light guide plate; and
a plurality of optical sensing elements disposed under a peripheral region of the bottom surface of the light guide plate, and each of the optical sensing elements having a sensing surface not parallel to the bottom surface, wherein the optical sensing elements are disposed at an illuminated region of the light beam provided by the at least one light-emitting element;
wherein a first portion of the light beam travels by total internal reflection in the light guide plate, and the light extraction structure allows a second portion of the light beam to leave from the bottom surface and project to the optical sensing elements.

2. The optical touch panel of claim 1, wherein a distance D between the sensing surface of the optical sensing element and the bottom surface satisfies a relationship below:
0<D<G tan(20°);
wherein G is a diagonal length of the top surface of the light guide plate.

3. The optical touch panel of claim 1, wherein a number of the at least one light-emitting element is plural, the light-emitting elements and the optical sensing elements are alternately arranged, and the light beam has a horizontal emission angle less than a vertical emission angle.

4. The optical touch panel of claim 1, wherein a number of the at least one light-emitting element is plural, the lateral surfaces adjacent to the light-emitting elements are different from the lateral surfaces adjacent to the optical sensing elements, and the light beam has a horizontal emission angle less than a vertical emission angle.

5. The optical touch panel of claim 1, wherein a number of the at least one light-emitting element is plural, and the light-emitting elements surround the lateral surfaces.

6. The optical touch panel of claim 5, further comprising a light reflection layer configured to reflect the light beam, and the light reflection layer is disposed on a region of the top surface adjacent to the light-emitting element.

7. The optical touch panel of claim 1, further comprising an optical coupling layer provided between the light-emitting surface of the at least one light-emitting element and the light guide plate, and a refractive index of the optical coupling layer being greater than air.

8. The optical touch panel of claim 7, wherein the optical coupling layer is a scattering structure layer, an optical adhesive layer or a combination thereof.

9. The optical touch panel of claim 1, wherein a region of the light guide plate facing the at least one light-emitting element has a plurality of microprism structures.

10. The optical touch panel of claim 1, wherein a region of the light guide plate facing the at least one light-emitting element is a rough surface.

11. The optical touch panel of claim 1, wherein the at least one light-emitting element faces the bottom surface.

12. The optical touch panel of claim 11, further comprising a first optical structure disposed in a periphery region of the light guide plate excluding the bottom surface to be opposite to the light-emitting surface of the at least one light-emitting element, wherein the first optical structure is a scattering structure layer, a specular reflection layer, a reflection structure, or a combination thereof.

13. The optical touch panel of claim 12, wherein the first optical structure comprises the reflection structure having a plurality of asymmetrical prisms, each of the asymmetrical prisms comprises a first oblique surface and a second oblique surface, the first oblique surface is closer to the lateral surfaces than the second oblique surface is, a length of the first oblique surface is greater than that of the second oblique surface, the first oblique surface reflects the light beam such that the light beam travels farther away from an optical axis of the at least one light emitting element.

14. The optical touch panel of claim 13, wherein the first optical structure further comprises the scattering structure layer or the specular reflection layer disposed on the reflection structure and the lateral surfaces.

15. The optical touch panel of claim 13, wherein the reflection structure satisfies a condition: Rₘₗ>2*T*tan(sin⁻¹(1/n)), in which R_{ML} is an extending length of the reflection structure extending outwardly from the lateral surfaces, T is a thickness of the light guide plate, and n is a refractive index of the light guide plate.

16. The optical touch panel of claim 12, wherein the first optical structure comprises the reflection structure having a reflection oblique surface located between the lateral surfaces and the top surface, and an included angle between the reflection oblique surface and the lateral surfaces is not smaller than 135 degrees and not greater than 179 degrees.

17. The optical touch panel of claim 16, wherein the first optical structure further comprises the scattering structure layer or the specular reflection layer disposed on the reflection oblique surface.

18. The optical touch panel of claim 17, wherein the specular reflection layer or the scattering structure layer further extends to be located on a partial region of the top surface of the light guide plate and the partial region of the top surface of the light guide plate has a width satisfying a condition: R_{S}≧T*tan(sin⁻¹(1/n)), in which R_{S} is a width of the partial region of the top surface, T is a thickness of the light guide plate, and n is a refractive index of the light guide plate.

19. The optical touch panel of claim 1, wherein a thickness of the light guide plate is between 0.1 mm and 10 mm.

20. The optical touch panel of claim 1, wherein a wavelength of the light beam is between 700 nm to 1000 nm.

21. The optical touch panel of claim 1, wherein the light extraction structure comprises a plurality of scattering particles inside the light guide plate.

22. The optical touch panel of claim 1, wherein the light extraction structure is a scattering layer disposed on the bottom surface.

23. The optical touch panel of claim 1, wherein the light extraction structure comprises a plurality of micro-structures at the bottom surface of the light guide plate, and a surface roughness of the bottom surface is greater than zero and less than 1 um.

24. The optical touch panel of claim 1, further comprising a control processor, wherein when an object contacts the optical touch panel, the optical sensing element corresponding to a contact position of the object outputs a contact characteristic corresponding to an attenuation of the second portion of the light beam, and the control processor calculates a coordinate of the object according to the contact characteristic and a connecting relation of the optical sensing element and the light-emitting element.

25. The optical touch panel of claim 24, wherein the greater a trough depth of the contact characteristic the closer the object to the light-emitting element.

26. The optical touch panel of claim 1, further comprising a light shielding layer disposed between the bottom surface of the light guide plate and the optical sensing element.

27. The optical touch panel of claim 26, wherein the at least one light-emitting element faces at least one of the lateral surfaces, and the light shielding layer reflects the light beam.

28. The optical touch panel of claim 26, wherein the at least one light-emitting element faces the bottom surface, and the light beam is permitted to pass through the light shielding layer.

29. The optical touch panel of claim 26, wherein the light shielding layer has a light permeable pattern, and the at least one light-emitting element provides a portion of the light beam to the light permeable pattern.

30. The optical touch panel of claim 1, wherein N numbers of the optical sensing elements are grouped into a sensing group for simultaneously receiving the second portion of the light beam and outputting a contact characteristic.

31. The optical touch panel of claim 1, wherein an included angle between an extending direction of the sensing surface of the optical sensing element and a normal direction of the bottom surface is within 30 degrees.

32. The optical touch panel of claim 1, further comprising a plurality of optical absorbing elements respectively disposed between adjacent two of the optical sensing elements, wherein the optical absorbing elements satisfies a condition: (W/H)<2*tan(90°−sin⁻¹(1/n)), in which W is a pitch of the adjacent two of the optical absorbing elements, H is a distance from a projection of a center of the sensing surface of the optical sensing element on the optical absorbing element to a tip of the optical absorbing element, and n is a refractive index of the light guide plate.

33. A touchscreen, comprising:
a display having a display surface; and
the optical touch panel according to any one of claim 1, wherein the bottom surface of the light guide plate of the optical touch panel faces the display surface of the display.

34. The touchscreen of claim 33, further comprising a medium layer between the display surface and the bottom surface of the light guide plate, wherein a refractive index of the medium layer is lower than a refractive index of the light guide plate.

35. The touchscreen of claim 33, wherein the light guide plate of the optical touch panel is a transparent material, and a haze of the light guide plate is lower than 20%.

36. The touchscreen of claim 33, further comprising a frame surrounding the display and the optical touch panel, and the frame having the same elevation as the top surface.

37. The touchscreen of claim 33, wherein the light guide plate is a cover lens, and the lateral surfaces of the light guide plate further have an arc shape portions connecting to the top surface.

38. The touchscreen of claim 33, wherein the light guide plate is a composite plate formed by stacking at least two different materials.
